(19) United States
(12) Patent Application Publication
(10) Pub. No.: US 2010/0249955 A1
(43) Pub. Date: Sep. 30, 2010

(54) RESOURCE CONSUMPTION CONTROL APPARATUS AND METHODS

(75) Inventor: Paul Edward John Sitton, London (GB)

Correspondence Address: BARLOW, JOSEPHS & HOLMES, LTD., 101 DYER STREET, 5TH FLOOR, PROVIDENCE, RI, 02903, US

(73) Assignee: THE ROYAL BANK OF SCOTLAND PLC, Edinburgh (GB)

(21) Appl. No.: 12/665,378

(22) PCT Filed: Jun. 12, 2008
(86) PCT No.: PCT/EP08/57433

§ 371 Date: May 12, 2010

(30) Foreign Application Priority Data
Jun. 20, 2007 (GB) 0711946.4

(51) Int. Cl. G05B 13/02

(52) U.S. Cl. 700/33

(57) ABSTRACT

A resource consumption management system for an environment measures resource use and occupancy and data is accessible via a graphical user interface that can show the contribution made by individuals. A location system tracks the location of individuals in the environment. Individuals are able to log preference values for the level at which resource consuming devices are running and those preference values are taken into account by a building management system in controlling the resource consuming devices at the tracked location of the individuals. Where the resource is energy, the system can show an individual the real time carbon footprint of energy usage in the environment at an individual level. Further, comparisons can be made between an environment and a reference measure of resource consumption such as that of another floor or another building.

The present invention relates to resource consumption control apparatus and to methods therefor. It finds particular application in control of energy consumption in workspace environments, such as by temperature control and lighting.

It is known to provide an overall control of environmental aspects of a workspace rather than leaving it entirely to the individuals present in the workspace to operate local switches and temperature controls. For example, U.S. Pat. No. 5,170,935 (MIT) discloses a centralised heating, ventilation and air conditioning (“HVAC”) control system which uses measured conditions to predict a comfort index and also receives real time user feedback regarding perceived comfort. The control system adjusts HVAC parameters accordingly. U.S. Pat. No. 7,003,378 (MMI Controls) discloses a HVAC control system that can be controlled by individual users, each having a personal identification number (“PIN”). The users are in different categories and have different permissions to use services, being for example tenants or the building owner. The users and/or categories can then be billed individually for service usage. U.S. Pat. No. 6,865,449 (Carrier Corporation) discloses a HVAC control system which calculates comfort factors, taking into account occupancy, building thermal characteristics and real time user feedback and adjusts HVAC parameters accordingly.

It is also known to calculate a “carbon footprint”, this being a measure of the amount of carbon dioxide emitted through combustion of fossil fuels. In the case of an organisation, this might be calculated in relation to their operation. In relation to an individual or household, this might be calculated in relation to lifestyle such as travel and waste disposal. In the case of a product or commodity, this might be calculated in terms of manufacture and transport to bring it to market. A carbon footprint calculation might be made so that relative carbon footprints can be taken into account by an individual making choices such as between commodities or modes of travel. Carbon footprint calculations might also be made to support carbon offsetting which is taking action to compensate for carbon dioxide release. Examples of carbon offsetting are planting trees or crops that absorb carbon dioxide.

It is also known to assess the carbon footprint of a national electricity supply. Electrical goods have no obvious carbon footprint at the time of use since they don't use fossil fuels but the generation of the electricity does. Having a conversion factor for converting a level of electricity usage to carbon footprint allows the direct comparison of electrical goods in terms of carbon footprint.

The carbon footprint of various goods and services can thus each be assessed so that the individual can make informed choices.

According to a first aspect of embodiments of the present invention, there is provided resource consumption control apparatus for controlling resource consumption by at least one resource consuming device in an environment, the resource consumption control apparatus comprising:

i) a user location signal input for receiving location signals indicating location of a user in the environment;
ii) a preference value reader for reading one or more preference values from a database in relation to the at least one resource consuming device for one or more users; and
iii) a control signal setting device and output for setting and sending one or more control signals to adjust the resource consumption of at least one resource consuming device in accordance with one or more preference values read from the database for a user whose location is indicated by a received location signal.

The resource in question might be for example energy.

A resource consuming device in an embodiment of the invention might be anything that consumes a resource, in use, such as a toilet or electrically driven equipment such as information technology equipment. Another example is an environmental control device which affects the environment of a user, such as a light, a fan or air circulating unit, a heater or an air conditioning unit, and consumes energy in doing that.

The resource consuming device may be powered in any appropriate way, for example by sunlight, wind, oil, gas or electricity, or even mechanically, but can consume more or less resource, depending on whether it is turned to a higher or lower level of activity. In the case of a toilet, the resource might be for example water and the toilet can be set to consume more or less water per flush. In the case of a light, a fan or a heater, the resource consuming device can be set to a higher or lower activity level. In the case of information technology equipment, it might be set to power down after longer or shorter periods of inactivity.

Although embodiments of the invention might obtain preference values by accessing a preferences database remotely, or might be designed to use a pre-existing database, and thus will include a preference values reader, it may be the case that the resource consumption control apparatus itself comprises a preferences database.

Embodiments of the present invention can be used to provide real time control of resource consuming devices in accordance with the presence of individual users detected in the environment who have previously stored one or more preference values in the preferences database. Such users need only to walk into an environment for it to be adjusted, if necessary, towards their preferred conditions. Although control of an environment via the preferences database may superficially appear less direct to the user than being able to adjust a temperature setting or dimmer switch on a wall, the response of the environment in real time can be quicker and easier since the user only has to appear in the environment for it to adjust towards their preference values.

Users having stored preference values will usually need to be identifiable when a location signal is received for them in relation to the environment, in order to relate them to their preference values. However, it is not essential that they are individually identifiable since a user might instead belong to a class of user having at least one shared or preset preference value. It would also be possible that at least some of the preference values are set according to the user's location. For instance, a new user might be allocated preset preference values according to their location in the building.

The preference values as set in the database will not usually be values for levels of resource consumption per se but will more conveniently be values for variables that affect resource consumption, such as temperature in relation to a heating or air conditioning unit and brightness in relation to a lighting unit. Thus the user might set a desired temperature or lighting level without having precise information about the level of resource consumption it relates to. Indeed, a preference value in practice would not usually convert directly to a resource consumption rate even for a single resource consuming device such as a heater since resource consumption in the context of a whole environment such as a building might depend on several factors. For instance, in the case of energy, some of the energy input might come from a renewable energy source, perhaps solar cells or a wind turbine. Another factor will be the efficiency of the various resource consuming devices themselves. However, the user may be able to receive feedback that effectively translates their chosen values into a measure of resource consumption or carbon footprint or the like, to enable them to choose to reduce it.

Therefore, the resource consumption control apparatus may further comprise a preference value processor for converting a set of one or more preference values to a measure of resource consumption. To support this, the resource consumption control apparatus may be provided with metering apparatus for metering resource consumption in relation to the environment. Once one has a measure of actual resource consumption, it becomes possible to convert preference values to a measure of actual resource consumption, potentially in real time or near real time. The measure of resource consumption may for example be provided as a carbon footprint or a change in carbon footprint.

The metering apparatus might for example measure the resource consumption of individual devices or, for example by metering electricity delivery, a floor of a building or indeed the whole building. A measurement in relation to a floor or a building can be converted to a measurement at the level of an individual simply by dividing by the number of people present, whether that's known or perhaps estimated based on historical values.

The control signal setting device may be adapted to set at least one of said control signals in accordance with one or more preference values stored in the preferences database for at least two different users for whom location signals have been received. This means that where an environmental control device will control the environment of two or more users at the same time, such as an overhead fan cooling unit in a small conference room, or one that delivers cool air over several workstations, it is possible to set the device at a level that takes into account the preferences of all the affected users. For instance, the device might be set according to an average of the relevant preference values, or to the highest.

A significant aspect of a preferences database as described above is that it can potentially be used to group users having similar preference values and to allocate users or groups of users to locations in the building which are more efficient in terms of resource consumption in light of their preference values. Thus for example users preferring low light levels could be allocated to workstations away from windows in a building, leaving users who prefer higher light levels to benefit from natural light.

The user location signal input for receiving location signals indicating location of a user in the environment will usually be adapted to receive location signals from a user detector in the environment. The location signal may be simply a signal indicating that the user has entered the environment or might indicate a specified location within the environment.

A user detector for use in generating location signals might detect the location of a user in any of several different ways and to any of several different degrees of accuracy. For example, the location of the user might simply be detected on entry to an environment. In this case, the user detector might be represented by a swipe card reader which reads a swipe card used to gain entry to the environment. If the swipe card carries for example a personal identification number (“PIN”), this can then be used by the energy consumption control apparatus to access the preferences database and read or download relevant preference values for the user for that PIN. Alternatively, the location of the user can be detected within the environment, using for example an active radio frequency identification tag (“RFID tag”) carried by the user. This is a known technology in which RFID devices emit their own identification codes either periodically or on activation by an antenna, the codes being picked up by receivers. If a device has been activated, it also picks up and then sends to the receiver a code for the relevant antenna. The location of the devices can be calculated based on the position of the activating antenna and/or of the receiver.

Since in an environment such as a workspace, several users are likely to share access to resource-consuming devices such as lights and air-conditioning units, a control signal in relation to the resource consumption of a device may be determined by the combination of preference values stored in the preferences database for all users whose locations are detected in the same time period by the user detector as having access to that device.

In this context, “the same time period” is likely to be defined by the user detector(s). If the user detector(s) detect entry and departure of a user to/from the environment, then it can be known accurately whether two or more different users are present simultaneously. However, if the user detector(s) send intermittent location signals showing the location of a user at different locations within the same environment, but not entry and departure, there may be a lag between entry/departure being reflected in a location signal. “The same time period” in this case might be defined by the period between receipt of the intermittent location signals.

In practice, in a working environment such as a building, the real time carbon footprint of modern energy usage is likely to be complicated by the use of various renewable energy sources such as wind turbines and solar roof panels. These can supplement electricity taken from the national electricity supply in various ways and the degree to which they do that will vary in real time with factors such as wind speed and solar irradiance. It has been realised in relation to embodiments of the present invention based on energy consuming devices that in practice, with most existing buildings, renewable energy sources only supplement rather than replace energy taken from the national electricity supply and the whole real time contribution of such renewable energy resources will be directly reflected in the total electricity taken from the national electricity supply, which can be metered. Thus the overall carbon footprint of a building, in terms of its energy supplies, is measurable in real time.

It has also been realised that while the element of that overall carbon footprint that can be attributed to any one individual would be difficult to assess, any change made in relation to energy consumption can be directly and accurately converted to the impact it will have on carbon footprint. The change might be made in any factor or combination of factors that the individual can control, directly or indirectly, to change the rate of energy consumption in one or more devices, such as fan controlled units for temperature control and/or lights. Although it can also be measured, it is not necessary to know the real time contribution of the renewable energy sources in order to assess the impact on carbon footprint of that change because the change will appear entirely in the electricity taken from the national electricity supply and can thus be converted directly to a change in carbon footprint.

A powerful aspect of embodiments of the invention is thus an ability to encourage changes in user behaviour in terms of resource consumption. Preferably, where the resource comprises energy, embodiments of the invention include a carbon footprint calculator for calculating a change in carbon footprint based on one or more preference values set by a user or a group of users. Where the resource consumption control apparatus is provided with metering apparatus for metering resource consumption in relation to the environment by one or more controllable devices which are subject to preference values, the carbon footprint calculator may receive, as a data input, energy consumption data from the metering apparatus which can then be broken down at the level of the individual for example by dividing by current occupancy of the environment. The calculator can then calculate a potential change in carbon footprint for an individual by applying one or more preference values of that individual instead of the metered values, for example as a percentage change in the energy consumption data at the individual level.

Having access to a measure of the carbon footprint change that can potentially be made, even in a shared environment, can be a very powerful incentive to make a reduction in energy consumption.

An example of calculating the carbon footprint change that might be made would be to measure the current energy consumption rate of all the lights on a floor of a building, to divide that consumption rate by occupancy and then to calculate a change in carbon footprint that would apply at the individual level if the lighting level were changed to a particular stored preference value.

According to a second aspect of embodiments of the present invention, there is provided resource consumption control apparatus for controlling resource consumption by at least one resource consuming device in an environment, the resource consumption control apparatus comprising:

i) a preference value reader for reading one or more preference values from a database in relation to the resource consumption of at least one resource consuming device for at least one user;
ii) a control signal device and output for selecting and sending a control signal to set the level of resource consumption of said at least one resource consuming device, the control signal being at least partly determined by at least one preference value read from the database;
iii) a resource consumption meter for measuring the resource consumption of said at least one resource consuming device; and
iv) a change calculator for calculating a change in relation to the measured resource consumption, which calculated change is attributable to one or more preference values for said one user in relation to the resource consuming device(s).

As mentioned above in relation to the first aspect of the invention, although embodiments of the invention might access a preferences database remotely, or might be designed to use a pre-existing database, and thus will include a preference values reader, it may be convenient that the resource consumption control apparatus itself comprises a preference values database.

Said one or more control signals may be at least partly determined by preference values read from the database in relation to said one user and at least one further user. Embodiments of the invention in its second aspect then allow the control of resource consumption in an environment shared by multiple users to be based on preference values for two or more of those users while still allowing an individual user to find out the effect on resource consumption their own preference value would have if the level of resource consumption was set by the control signal device according to their individual preference value(s).

For example, the resource might comprise energy in which case the resource consumption control apparatus controls energy consumption, the one or more preference values relate to energy consumption, the meter measures energy consumption and the change calculator calculates a change which relates to energy, such as a change in carbon footprint.

Embodiments of the invention are contemplated where the resource consuming device(s) is/are environmental control device(s) such as devices for controlling temperature or light delivery to the environment.

A calculated change such as a change in carbon footprint can be stored, displayed and/or transmitted on a network as data. Usefully though, it might be made available in real time to the user who then can obtain information about an impact on resource consumption they may have as a result of their stored preference value(s), such as a reduction in carbon footprint should they reduce one or more preference values.

Embodiments of the invention in its second aspect do not require a user to be present in an environment in order for that individual's potential impact to be assessed. An individual can set or change one or more of their preference values and see a theoretical impact, for example on carbon footprint. In practice, the setting of or change in preference value(s) will be subsequently implemented when the individual later enters the relevant environment, by means of the control signal setting device, and it is likely to be mitigated by the preference levels of other users in the environment.

Preferably, embodiments of the invention in any of its aspects will include a user interface for receiving preference value inputs for entering or modifying preference values in the database. In embodiments including a change calculator for calculating a change in relation to the measured resource consumption, the change calculator preferably has a display signal output to the user interface for displaying a calculated change and such a display signal might be sent for example in response to a received preference value input. This has considerable value since a user can then see very directly how their preference values affect resource consumption in the environment. An example would be a display signal showing a calculated change in carbon footprint, triggered by entry or a change in preference value entered by the user. Alternatively, the change calculator might be adapted to calculate a difference between resource consumption per user in the environment and in a reference environment such as a control floor or building.

One method of calculating a change in carbon footprint in relation to the measured energy consumption of an energy consuming device might comprise the following steps:
i) divide the measured energy consumption by the number of people present in the environment, for instance the real number or an estimated number, so as to obtain a figure for measured energy consumption at the individual level;
ii) multiply that figure by a difference between at least one preference value stored for said at least one user and the level of energy consumption set by the control signal device, to obtain a measure of the change in energy consumption that would occur if the preference value were substituted for the level of energy consumption set by the control signal device; and
iii) convert that measure of change in energy consumption to a measure of carbon footprint in relation to the environment.

In practice, in an environment where changes in energy consumption will appear entirely in the power taken from a national electricity supply, the conversion to carbon footprint can be done simply by using a known conversion factor for the relevant electricity supply.

According to a third aspect of the present environment, there is provided a method of controlling resource consumption by one or more resource consuming devices in an environment, the method comprising the steps of:

i) detecting the location of at least one user in the environment;
ii) obtaining at least one preference value relating to resource consumption in respect of the at least one user; and
ii) sending a control signal to a resource consuming device relevant to the location, the control signal being at least partly determined by the at least one preference value.

According to a fourth aspect of the present environment, there is provided a method of controlling resource consumption by one or more resource consuming devices in an environment, the method comprising the steps of:

i) obtaining at least one preference value relating to resource consumption in respect of at least one user;
ii) sending a control signal to set the level of resource consumption of a resource consuming device relevant to the environment, the control signal being at least partly determined by preference values for said at least one user and at least one further user;
iii) measuring the resource consumption of said at least one resource consuming device; and
iv) calculating a change in relation to the measured resource consumption, which calculated change is attributable to one or more preference values for said one user in relation to the resource consuming device.

It is to be understood that any feature described in relation to any one embodiment or aspect of the invention may be used alone, or in combination with other features described, and may also be used in combination with one or more features of any other of the embodiments or aspects, or any combination of any other of the embodiments or aspects, if appropriate.

An energy management system will now be described as an embodiment of the present invention, by way of example only, with reference to the accompanying figures in which:

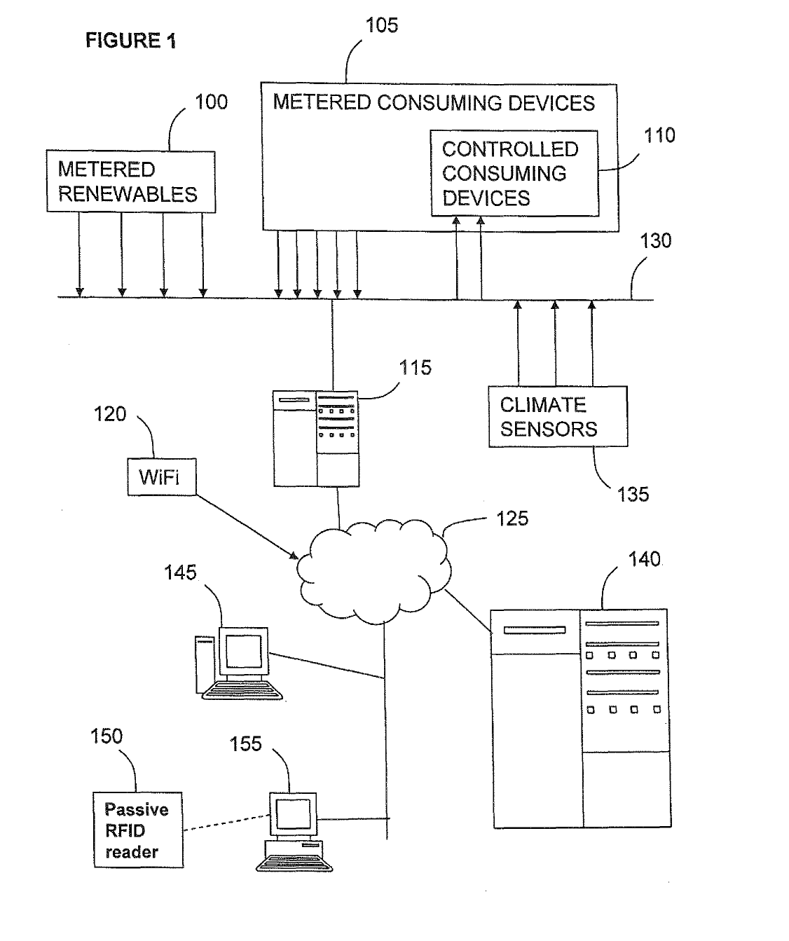

FIG. 1 shows a schematic view, in functional blocks, of the energy management system in a network environment for installation in relation to a building;

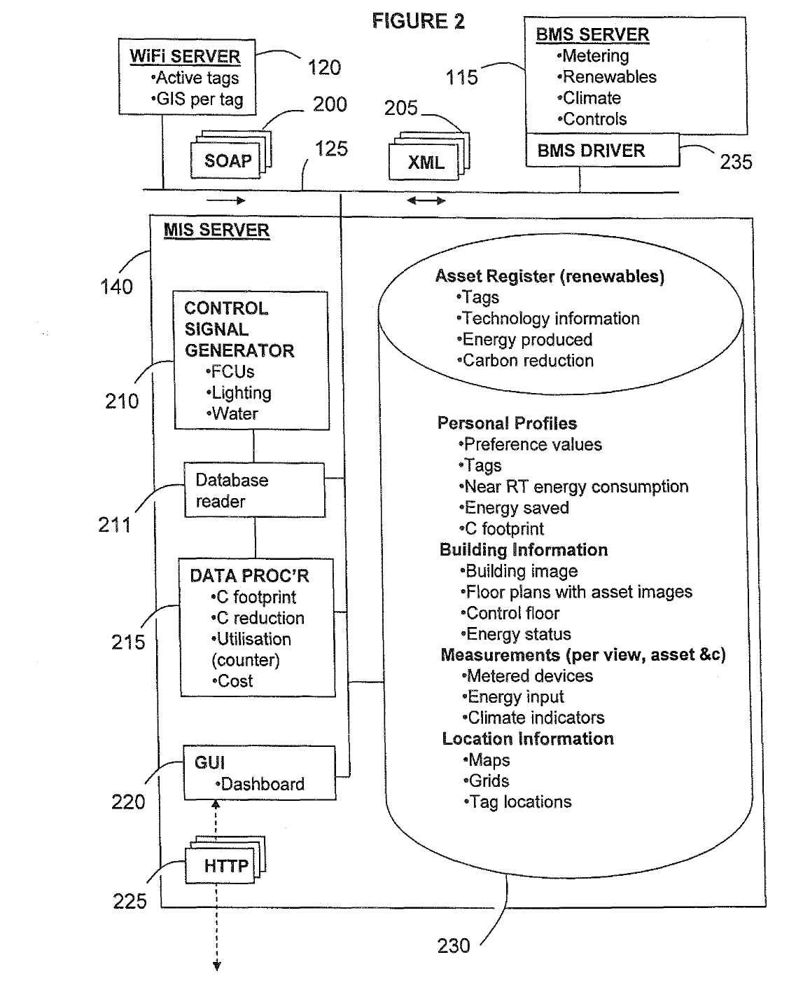

FIG. 2 shows a functional block diagram of a management information system for use in the energy management system of FIG. 1;

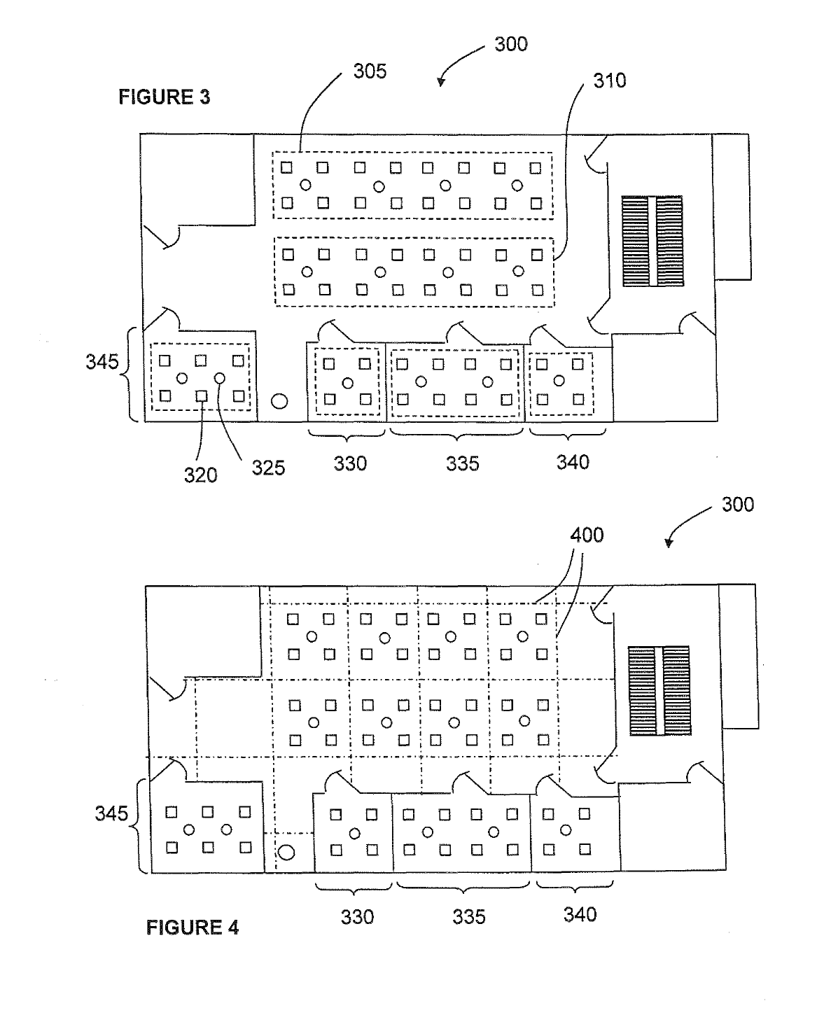

FIG. 3 shows in plan view a schematic arrangement for functional grouping of environmental control devices by the management information system of FIG. 2;

FIG. 4 shows in plan view a schematic grid overlay for use in monitoring location of users by the management information system of FIG. 2;

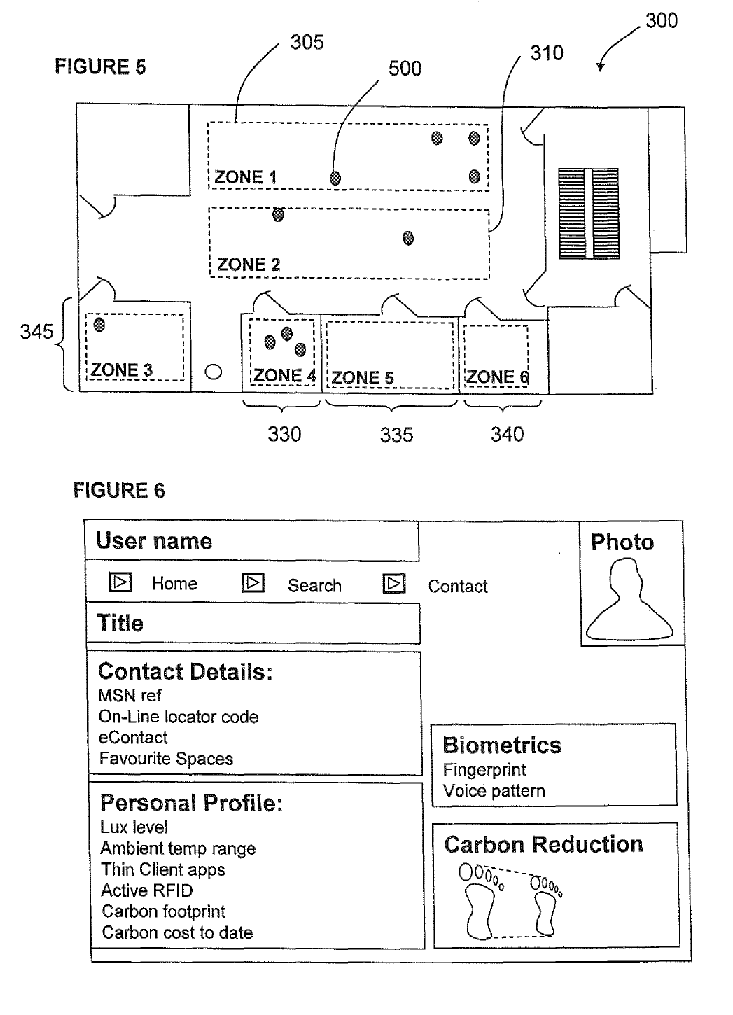

FIG. 5 shows a screen display of a graphical user interface for showing the location of users monitored by the management information system of FIG. 2;

FIG. 6 shows a screen display of a graphical user interface for obtaining carbon footprint data from the management information system of FIG. 2; and

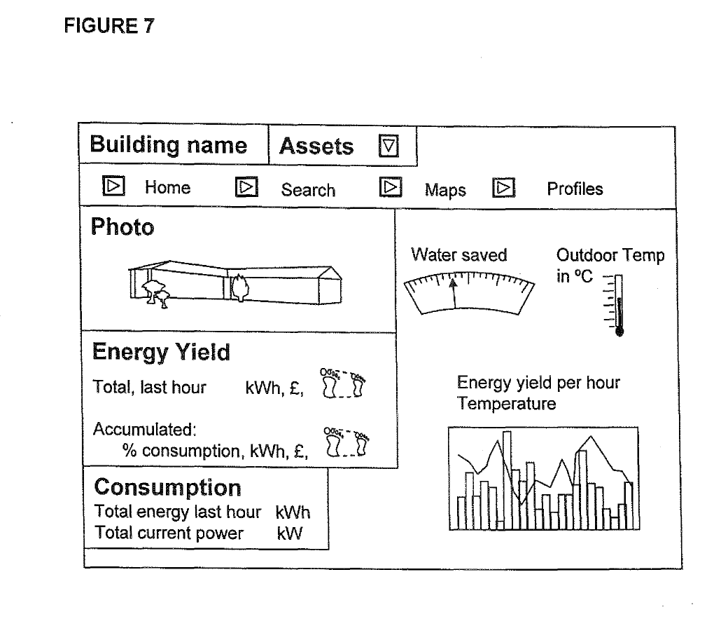

FIG. 7 shows a screen display of a graphical user interface for obtaining building information from the management information system of FIG. 2.

### 1. OVERVIEW OF EMBODIMENTS OF THE INVENTION

Referring to FIG. 1, the energy management system provides comprehensive visibility and control of energy resources in a building at both a collective and an individual level. Energy is provided from a combination of local renewable sources 100 and via the national electricity supply and delivered to a range of energy-consuming devices 105 such as lights and air conditioning units. The level of energy consumption is controlled to a certain extent by individuals, and to a certain extent collectively, via a management information system (“MIS”) 140 which stores preferences for individuals which the MIS 140 uses in setting the level of activity of the energy-consuming devices 105. Real time measurements of delivered power to the building and to locations and devices in the building, from both the renewable sources 100 and the national electricity supply, support real time provision of carbon footprint data. By also tracking location of individuals in the building and the effect of their current preferences on energy-consuming devices 105 local to them, carbon footprint data can be delivered on an individual basis. Additionally, the stored preferences can be used to group individuals of similar preferences and to place the groups in appropriate places in the building so as to optimise power consumption.

A graphical user interface (“GUI”) of the MIS 140 provides real time data and historical data on power, energy consumption and carbon footprint for the whole building, locations in the building and for individuals or groups of individuals and energy consuming devices 105 in the building. The GUI can be accessed from user workstations 145, 155 to run reports and updates on the data in the MIS 140. The main objective of the MIS is to drive a continuous process of energy conservation and carbon footprint reduction and this is done by making information available at every level, from the whole building through to individuals, in spite of the complex nature of a shared working environment.

Data comes into the MIS 140 directly from:
a location server 120
a building management server (“BMS”) 115
user workstations 145, 155

Data comes into the MIS 140 via the BMS 115 from:
meters measuring the energy produced by the renewable sources 100
meters measuring energy consumption by the energy consuming devices 105
climate sensors 135 sensing climate factors such as air temperature (° C.) and solar irradiance (w/m)

Control signals go out from the MIS 140 via the BMS 115 to controllable energy consuming devices 110, these being a subset of the energy consuming devices 105. Controllable energy consuming devices 105 might include for example one or more boilers which can be turned down on warmer days for example, and also devices which can be adjusted to adapt local conditions such as heating and lighting in response to a combination of user preference values and user location.

Referring also to FIG. 2, the MIS 140 is connected to a network 125 such as the Internet which can carry messages 200, 205, 225 in a variety of protocols. The MIS 140 supports for example the known protocols XML (Extended Markup Language), SOAP (Simple Object Access Protocol) and HTTP (Hyper Text Transfer Protocol). In particular, it communicates with the BMS 115 based on XML, the location server 120 based on SOAP and with user workstations 145, 155 based on HTTP.

### 2. BMS 115

The BMS 115 is a building management system of known type, supplied by Trend Control Systems Limited, for example, the Trend IQ3. This type of building management system is based on a plurality of controllers and a supervising function (called a “supervisor”) which can be used to send control signals to selected devices via the various controllers. It can be readily grown by the addition of further controllers. The BMS 115 reads data from meters and sensors distributed around the building which are designed or adapted to communicate over a local operating network (“LON”) 130. It also tracks energy being provided to the building in real time by renewable energy sources 100 and can send control messages out on the LON 130 to the controllable energy consuming devices 110, in this case lights and air conditioning units.

It is known to read and control building equipment over a network. There are several protocols capable of supporting building management of this type, including for example LonWorks (registered trade mark of Echelon Corporation), DALI and BACnet. DALI stands for digital addressable lighting interface and it is an international standard for communication which defines commands for addressable ballasts. BACnet is a data communication protocol for building automation and control networks which is an ISO global standard and a national standard in more than 30 countries.

It is a known problem that these protocols are not necessarily compatible without providing a gateway, LonWorks and BACnet being an example of such a pair. It is also known to write software which is protocol neutral to overcome the incompatibility and Tridium Incorporated for example offer a software platform designed to be both vendor and protocol neutral and which can present the various systems in a building via a unified, easy to navigate web site which gives access to real time data and alarms.

The BMS 115 therefore has installed on it a Tridium software platform and can thus support all of LonWorks, DALI and BACnet interfaces. As mentioned above, the BMS 115 then interacts with the MIS 140 using an XML interface which allows data to be obtained from the BMS 115 at the MIS 140 and also allows data to be set in the BMS 115 from the MIS 140 for controlling the controllable energy consuming devices 110.

### 2.1 XML Interface 235

In practice, there is a need for an interface driver 235 to deal with the interface between the BMS server 115 and the MIS server 140. This listens for a TCP/IP connection in which it expects XML requests from the MIS server 140 in a specific format. If the request is for data, the interface driver 235 will reply to the MIS server 140 in XML with requested values. Effectively, the device translates an XML request into a Trend request and sends it to the correct Trend controller, and on the other hand translates a Trend response into an XML response to the MIS server 140.

Once installed, the XML side of the interface driver 235 will listen for a TCP/IP connection to the MIS server 140 on port 8080 and, once the connection has been made, it will read from it until a valid XML request has been received. Then it will process the XML request, send the information or request to devices specified in the request and then wait for another request. Only one connection is handled at a time. If a new connection is attempted, the old one is closed and discarded. There is no need to drop the connection after every request since it can be kept open to continue the communication.

The BMS (or “Trend”) side of the interface driver 235 maintains a connection to the BMS server 115 and if it receives a reply from a Trend device originated from an XML request, it will send it to the MIS server 140 as XML responses as the information arrives from the Trend controllers.

Requests for different controllers will be treated as different requests, so the responses will be in different messages. Also, depending on the number of points (connection points to different devices) in a request, the response may also be split into different messages.

The communication is asynchronous, so replies are sent as they arrive from the Trend devices, which may not necessarily be the order in which the XML requests were made.

The XML format used is as follows:
XML header: fixed text and must always be present at the beginning of the message.
Communication element: only one in a message, and must enclose all other elements (except for the header). It can (only) contain any number of operations.
Operation element: at least one, always within a communication element. It can (only) contain any number of controllers. The OperationType attribute must also be present and might be:
   “SetValues” for writing into Trend.
   “GetValues” for reading from Trend.
   “Response” will be a response to a “GetValues” operation.
   “SetValues” has no response.
Controller element: at least one, always within an operation element. It can (only) contain any number of modules. The LAN and operating system (“OS”) attributes must also be present. There is also a PinNumber attribute which is optional.
Module element: at least one, always within a controller element. It can (only) contain any number of parameters. The ModuleType and ModuleNumber attributes must also be present.
Parameter element: at least one, always within a module element. It cannot contain any other elements, and is expected to be open and closed in the same tag. The ParameterType attribute must also be present, and the Value attribute must be present on “SetValues” operations.

An example of an XML message which would set the label and value for “Knob 1” and “Sensor 1”, and then would request them to ensure the changes took place, is as follows:

```
<?xml version=“1.0” encoding=“UTF-8”?>
<Communication>
    <Operation OperationType=“SetValues”>
        <Controller LAN=“0” OS=“20”>
            <Module ModuleType=“K” ModuleNumber=“1”>
                <Parameter ParameterType=“$” Value=“Setpoint”
            />
                <Parameter ParameterType=“V” Value=“21” />
            </Module>
            <Module ModuleType=“S” ModuleNumber=“1”>
                <Parameter ParameterType=“$” Value=“Remote
            Temp”/>
                <Parameter ParameterType=“V” Value=“20.2” />
            </Module>
        </Controller>
    </Operation>
    <Operation OperationType=“GetValues”>
        <Controller LAN=“0” OS=“20”>
            <Module ModuleType=“K” ModuleNumber=“1”>
                <Parameter ParameterType=“$” />
                <Parameter ParameterType=“V” />
            </Module>
            <Module ModuleType=“S” ModuleNumber=“1”>
                <Parameter ParameterType=“$” />
                <Parameter ParameterType=“V” />
            </Module>
        </Controller>
    </Operation>
</Communication>
```

An example of a response to this XML message is as follows:

```
<?xml version=“1.0” encoding=“UTF-8”?>
<Communication>
    <Operation OperationType=“Response”>
        <Controller LAN=“0” OS=“20”>
            <Module ModuleType=“K” ModuleNumber=“1”>
                <Parameter ParameterType=“$” Value=“Setpoint”
            />
                <Parameter ParameterType=“V” Value=“21” />
            </Module>
            <Module ModuleType=“S” ModuleNumber=“1”>
                <Parameter ParameterType=“$” Value=“Remote
            Temp”/>
                <Parameter ParameterType=“V” Value=“20.2” />
            </Module>
        </Controller>
    </Operation>
</Communication>
```

### 3. LOCATION SERVER 120

Referring to FIGS. 3 to 5, in order to provide local control of the environment in the building to users, it is necessary to track where the users are in the building and to be able to relate that to controllable devices 110. FIGS. 3 and 4 each show a floor plan 300 which has lights 320 arranged in clusters of four around fan control units 325 which control the level of heating or air conditioning. There is a central open plan area 310 and an open plan area near the windows 305, both of these having four clusters of four lights 320 each and each cluster being arranged around a fan control unit 325. On the side of the building away from the windows, there are four conference rooms 330, 335, 340, 345. FIG. 5 shows an example of a screen display that might be used to show where tracked users are in relation to the floor plan 300, using in this case oval markers 500.

Each of the lights 320 and fan control units 325 is separately controllable via the BMS 115. The level of lighting and heating/air conditioning will be set in accordance with the location of users detected in relation to the floor plan and this is achieved via the location server 120 which receives detection inputs in relation to users and transmits user location data in relation to the floor plan to the MIS 140.

FIG. 4 shows one way of relating detection inputs to the floor plan. The floor plan is broken up into cells by grid lines 400, each cell generally containing a cluster of four lights 320 and a shared fan control unit 325, except for the conference rooms 330, 335, 340, 345 which are each treated as a cell. In practice, the clusters of four lights 320 in the open plan areas 305, 310 may be situated over a set of user workstations affected by the shared fan control unit 325. Once a user is detected in a cell, this positions the user sufficiently accurately in relation to the floor plan to adjust lights 320 and a fan control unit 325 if necessary, according to the preference values that user has stored in the MIS 140.

There is more than one way in which the location of the user can be detected. For example, the user might carry or wear a RFID tag, this being a radio frequency identification tag. As mentioned above, RFID devices emit their own identification codes either periodically or on activation by an antenna, and the codes can be picked up by receivers. If a device has been activated by an antenna, it also picks up and then sends to the receiver a code for the relevant antenna. The location of the devices can be calculated based on the position of activating antennae and/or of the receiver(s). An alternative is to use Bluetooth technology. This can include received signal strength indication (“RSSI”) by a Bluetooth-enabled device and can be used to produce location information by arranging Bluetooth transmitters or markers in a grid. The transmitters or markers send identification signals that are picked up by the Bluetooth-enabled device which adds RSSI data, its own identifier and a time stamp and sends that data to the location server 120. This can then relate the position of the Bluetooth-enabled device to the relevant transmitters or markers and thus to a position on the floor plan. A third alternative in the case of the conference rooms for example is that a user wishing their preference values to have an influence on the environment in the room would pass a swipe card over a reader at the door.

Once the location of a user has been detected, this is stored and updated as necessary on the location server 120. The data can be sent to or read by the MIS 140 on a regular basis for use in setting control data in the BMS 115 when the location system detects a new user or a user who has moved to a new position on the floor plan.

In order to relate a user to their preference values, it will usually be necessary that they are identifiable and this can be based on the RFID code, Bluetooth transmissions or swipe card code. However, as mentioned above, the user may not have to be individually identifiable as they may for example belong to a class of user having preset preference values. Indeed, it is not essential that they are identifiable at all as user preferences could also be set independently of the user identity, for example in accordance with user location and/or time of day.

### 4. MIS 140

The MIS 140 comprises a server carrying a combination of data and software. The data falls into five categories:
an asset register (renewable energy sources)
personal profiles (identifiable users)
building information
measurements (meters and sensors)
user location

The software provides at least three functions:
a control signal generator 210 to send control signals via the BMS 115
a data processor 215 to calculate current values for energy-related variables such as carbon footprint
a graphical user interface 220

The MIS 140 overall thus provides resource consumption control apparatus which can receive location signals indicating location of an identifiable user in the environment from the location server 120 and the control signal generator 210 provides a control signal setting device.

### 4.1 MIS Database

### 4.1.1 MIS Database 230: Asset Register

Taking these things in turn, the asset register stores information particularly about the renewable energy sources 100 such as photo-voltaic cells and wind turbines that the building may be supplied with. In particular, the asset register holds RFID tag data for each energy source 100 and information about the technology concerned. It also holds current and historical data for energy produced and what this represents in reduction in carbon footprint compared with if the same energy were produced from fossil fuel sources.

The asset register of the MIS database 230 will show data for any asset defined as such at the time of implementation. However, information about any other asset may be added or deleted via a web interface at any time. Assets are not necessarily renewable energy sources 100 but may include any asset of a building for which technical information might be of use. Immobile assets such as a biomass boiler will usually carry a passive RFID tag but mobile assets might carry active RFID tags. Potential assets that might be entered in the asset register include for example:
photovoltaic roof tiles and solar panels
bio-mass boilers
wind turbines
rainwater recovery systems
DALI lighting systems
self cleaning window glass
waterless urinals
grey water recycling

### 4.1.2 MIS Database 230: Personal Profiles

The personal profiles hold, for each registered user, RFID tag data, preference values for environmental factors such as lighting levels and temperatures, a share of current energy consumption, a measure of energy saved in relation to a baseline measurement and measures of carbon footprint based on accumulated individual footprint in relation to a building and on current preference values. The personal profiles thus provide a preferences database for registered users. A baseline measurement in this context might be for example a measure of energy usage in a control building with no renewable energy sources, or a floor of such a building. The measure of carbon footprint might be for example to show how much carbon emissions were last reduced by a change in preference values leading to a decreased dependency on non-renewable energy sources.

The personal profiles also conveniently hold more general management information for the users which isn't necessarily used by the MIS 140 directly in relation to energy consumption but is useful for other purposes, such as contact details, employment details and data access and physical access authorities.

### 4.1.3 MIS Database 230: Building Information

The building information category of data comprises general data to do with the building that might be used in reports. This might comprise images of the building, floor plans with images of the renewable energy sources 100 or other assets present, data from a control floor or other reference environment for benchmarking purposes and the energy status of the building as a whole. A reference environment might be for example a floor of the same building but without the same environment control, or a comparable floor of another building with fewer or no energy saving measures such as renewable energy sources 100. The data might be metered electricity supply to that control floor for example. The energy status of the building as a whole might be the total energy consumed per hour, day or month, measured for example by the amount of electricity supplied to the whole building plus the amount of energy supplied by the renewable sources 100.

### 4.1.4 MIS Database 230: Measurements

The measurements from meters and sensors comprise the raw data obtained via the BMS 115 from all metered electricity supplies, energy consuming devices 105, renewable energy sources 100 and climate sensors 135. The meters provide the primary data supporting energy status and carbon footprint based reports while the sensors support control of heating and lighting under real time climate conditions.

In order to support energy status and carbon footprint based reports, metering in a building must be comprehensive and might therefore cover the following:
electricity supplied from a national electricity supply and other non-renewable resources, measured at a main building incomer
electricity supplied to each floor measured at the riser(s)
on each floor, the electricity consumed by the energy-consuming devices 105 such as water heaters, measured at lighting distribution boards and each of an array of condensers feeding the fan control units 325

In order to have a positive measure of the contribution made by each renewable energy source 100, it is also necessary to record the electricity generated by each source 100. Otherwise there may be no absolute measure of this contribution which might only appear for example as a reduction in the overall electricity consumption of a building or floor. The level of output is measured as a standard feature of renewable energy sources 100 and this data is recorded in kWh in the MIS 140.

Lastly, to support control of heating and lighting under real time climate conditions, sensors measure outside temperature and solar irradiance.

### 4.1.5 MIS Database 230: User Location

The user location data includes maps of the various floors of a building, any grid lines 400 that might apply and the locations of any currently detected users carrying active RFID tags or other location devices.

### 4.2 MIS Software

### 4.2.1 MIS Software: Control Signal Generator 210

Moving to the software components of the MIS 140, the first of these listed above is the control signal generator 210 for calculating and sending control signals via the BMS 115 and LON 130 to controlled energy consuming devices 110 in the building such as fan controlled air conditioning or heating units 325 and lights 320. The control signals can take into account ambient conditions such as outside temperature and solar irradiance in known manner so that for example lights are not run at the same brightness when there is ample sunlight available. Adjustment of heat and light provision in response to ambient conditions is known. However, importantly, it is also possible to take into account user preferences stored in the personal profiles for each registered user. This can be done whenever the location server 120 indicates a new location of an active registered user. The control signal generator 210 thus has access to a database reader 211 for reading relevant data from the database 230, such as preference values, building and location information. If the user is the only active registered user at a particular location, it is an easy matter to trigger the control signal generator 210 to read that user's preferences values and to adjust heat and light provision accordingly. However, in the more complex environment of workspaces, there will usually be multiple users affected by the same fan controlled air conditioning or heating units 325 and lights 320. This is dealt with in the case of the fan controlled air conditioning or heating units 325 by setting an operating level which represents the average preference values of the affected users. In the case of lights however, it can be important that a user can see sufficiently well and thus the operating level of the lights 320 will be set at the maximum preference value for the affected users.

It would be possible to control each cluster of four lights 320 and their shared fan controlled unit (“FCU”) 325 separately. However, that entails quite a high level of data processing as users are monitored moving around a floor plan. Particularly in open plan areas such as the open plan areas 305, 310 shown on FIGS. 3 and 4, it may be found efficient to designate zones in which all the lights 320 and FCUs 325 present in the zone are to be sent the same instruction. Each zone might then be considered an “environment” in embodiments of the invention. FIG. 5 shows a set of six zones, these being the two open plan areas 305, 310 and each conference room 345, 330, 335, 340, together with markers 500 showing the location of each monitored user. The MIS server 140 sends control messages to the BMS server 115 in order to implement the control of the lights and FCUs in accordance with the preferences of the monitored users present. A message from the MIS 140 to the BMS server 115 for that purpose might therefore contain:
an indication that the message relates to lights 320 or FCUs 325
an indication that the message is a control message
a BMS system reference
a zone ID and a value giving a lighting level for a message relating to lights
or a FCU ID and a value giving a temperature for a message relating to FCUs 325

The BMS server 115 would need to be able to interpret each zone ID in terms of the lights 320 it includes but this can be done simply for example by using tables or pointers, depending on the software technology in use.

Zones may be defined for various reasons but clearly any grouping of lights 320 and FCUs 325 which are likely to be subject to similar user preferences might lend themselves to be defines as a zone. In the arrangement of FIG. 5, two open plan areas 305, 310 are each presented as a zone, one being nearer the window. Each of these two different zones is likely to experience relatively uniform ambient conditions, the open plan area 305 near the window for example being subject to higher natural light levels, and are likely thus to be subject to similar user preferences.

Another factor in multiplying an environment into zones is that it is difficult at first sight to control the temperature of an open plan area to any degree of granularity. Hence any open plan area tends to lend itself to being a zone. However, it would be possible to split up each open plan area 305, 310 into workable smaller zones (“environments”) by the use of known technology such as heat curtains, although this can be difficult in practice.

A factor that might be used by the MIS 140 in selecting a control messages to send to the BMS server 115 is time of day. Thus after a certain time in the evening, all zones might be switched to different light and FCU levels of operation. Cleaners and security staff might be tracked, for instance having their own RFID tags, and the MIS 140 would then send control messages setting “night scene” light and FCU levels for zones the cleaners and security staff are tracked in.

### 4.2.2 MIS Software 210, 215: Energy Data Processor 215

A second category of software is the energy data processor 215 supporting data output to users via the graphical user interface 220. This energy data processor 215 can read data from the database 230 via the database reader 211 and operates on the measurements from meters and sensors to obtain a view of both general energy utilisation in the building or floor of a building, such as contribution made by renewable sources 100, overall usage and cost, and also an individual user's contribution in light of their preference values. Where carbon footprint is concerned, this is calculable for the building or floor by looking at the proportion of energy supplied by the renewable sources 100 of the total energy consumed. It is more complicated to calculate a carbon footprint for an individual as there is no one-to-one relationship between what the user selects in terms of location in the building and preference values. Here it is necessary to bring in user location data and preference values in the context of control signals sent by the control signal generator 210 to adjust heat and light provision. A change in carbon footprint for an individual can be calculated each time a control signal is sent to adjust heat and light provision as a consequence of an action by that individual. Thus if a registered user moves into a new cell of a floor plan, the cell containing four lights 320 and a shared fan control unit 325, or changes their preference values in the MIS database 230, and that movement or change results in the outputting of a control signal to adjust heat and light provision in that cell, then the consequent and calculable change in carbon footprint can be assigned to that user.

The principal factor in carbon footprint of a building is the extent to which it uses renewable energy sources 100 in place of conventional carbon-based energy sources such as the national electricity supply. At any one time, the contribution of renewable energy sources 100 will be determined by the efficiency of the sources concerned and the climatic conditions driving them, such as wind speed and solar irradiance. These are not affected by user location or preference values. If a user causes a change in the heat and light provision to any location in the building, the effect on carbon footprint is determined by the change in the proportion of energy supplied to the building by its renewable energy sources 100. To calculate carbon footprint, including any change in carbon footprint that's attributable to a user, the energy data processor 215 assumes that any change in the level of electricity supplied will appear entirely in the level of energy supplied to the building by non-renewable energy sources. A change in carbon footprint can then be calculated from this shift in the proportion of energy consumption to or from non-renewable resources. The energy data processor 215 can therefore be described as a “change calculator” whether or not there has been a change in one or more stored preference values.

It might be noted that although a user may take action that at face value would reduce carbon footprint, such as reducing their preference values for heat or light, there will be circumstances in which there will be no actual reduction in the level of energy supplied. This would occur for example if the preferences of all registered users present in a cell of a floor plan mean that a change made by just one user is not sufficient to result in the output of a control signal by the control signal generator 210. However, a theoretical reduction can be calculated by the energy data processor 215 for that one user for the circumstance in which all relevant users set their preference values to the preference value set by that one user. This allows the one user to see the potential reduction that would be made in accordance with that preference value, at the individual level. This calculation is further detailed below.

Energy consumption and carbon footprint calculations can be made for each floor of a building and for individuals on that floor. In the formulae given below, “PEOPLE1” is an estimate for the actual average number of people on a floor during a relevant hour:
C-PER-ENEh: Average energy per person consumed in the last hour (kWh)=the metered electricity from the national supply to that floor, divided by PEOPLE1
C-PER-FTPh: Carbon footprint per person on that floor for the last hour=C-PER-ENEh multiplied by a standard carbon conversion factor (“CCF”, currently 0.43 in the United Kingdom) for electricity from the national supply
C-PER-ESh: Energy saved per person in the last hour due to use of renewable sources 100=the energy yield of those sources in the last hour, divided by PEOPLE1
C-PER-CRh: Carbon footprint reduction in kilograms of carbon dioxide per person in the last hour due to use of renewable sources 100=C-PER-ESh multiplied by CCF
C-PER-CSh: Energy cost saved per person in the last hour due to use of renewable sources 100=C-PER-ESh multiplied by the cost per kilowatt of energy (“KWHCOST”)
C-PEER-FTPh: For comparison purposes, carbon footprint per person for the last hour on a control floor=the metered electricity from the national supply to the control floor, divided by the usual number of people on that floor for that hour and multiplied by CCF

All of the above are based on the electricity delivered to a floor and, where calculated per person, simply averaged over the number of people on the floor. However, it is also possible to show an effect of personal choice by quantifying energy use according to the settings chosen by individuals in their personal profiles. In the following, “NORMLUX” and “NORMTEM” are the actual normal lighting level and room temperature for an area in which an individual is located, “SELSCENE” is the lighting level (or “lux level”) an individual has selected in their personal profile and “SELTEM” is the room temperature an individual has selected in their personal profile.
C-PER-CCR: The change in individual carbon footprint per hour as a result of changes in the settings for light and temperature to match a personal profile=the metered energy consumption of the lights for the floor in that hour (“C-DALI-ENEh”), divided by PEOPLE1, multiplied by (NORMLUX−SELSCENE), multiplied by CCF and by a correction factor (“CORRF1”)+the metered energy consumption of the air conditioning units in that hour (“C-ACF1-ENEh”), divided by PEOPLE1, multiplied by (NORMTEM−SELTEM)/100, by CCF and by a second correction factor (“CORRF2”)

Written mathematically,

C-PER-CCR=CCF*(C-DALI-ENEh/PEOPLE1)*(NORMLUX−SELSCENE)*CORRF1+CCF*(C-ACF1−ENEh/PEOPLE1)*(NORMTEM−SELTEM)/100*CORRF2

In practice, it isn't realistically possible to measure a change in carbon footprint per hour as an immediate result of a change in settings in the personal profile. Energy reduction is only measured for the whole floor and only at hourly intervals. An individual's change of settings (lux level and temperature) will affect that measured value very marginally, if at all, and it would normally take at least an hour before it can be indicated. It is however possible to calculate a figure for the individual's effect on carbon footprint (C-PER-CCR) theoretically which will be reasonably accurate and can be indicated straight away. This allows a change in carbon footprint to be made directly visible to the individuals so they can immediately see how much carbon dioxide they would save by reducing their lighting level and preferred room temperature.

The formula for C-PER-CCR is based on assumptions which have been found reasonable in practice but which can anyway be modified easily to fine tune the result. A first assumption is that the energy consumption of the DALI lighting units, C-DALI-ENEh, shows a linear relationship to the lux level in percent. CORRF1 is present so that adjustment can be made if necessary, although it can simply be set to “1”. A second assumption is that 1° C. temperature change corresponds to a linear energy reduction of 1%. Within the narrow interval possible for temperature selection in a working environment this should be a reasonable assumption. This second assumption can, however, be modified by the other correction factor (CORRF2).

C-PER-CCR has two components, light level and temperature setting, and they have different roles in the carbon footprint of the individual. Light settings are measured as the percentage of the maximum light setting available and thus a current light setting for the lights in a zone of the floor plan (NORMLUX) might be for example 95%. This is set by the registered user present in the zone who has the highest preference value for SELSCENE. If a second registered user present in the zone has set their preference value for SELSCENE to be 80%, in practice this has no actual effect on the current light level in the zone. However, it is taken into account in calculating C-PER-CCR as can be seen above, as a carbon footprint reduction that would be made if the second user could set the light level in the zone. It would thus appear in the “Dashboard” information for that second user. The preference value set by a registered user for SELTEM on the other hand will usually be a real time factor in the actual carbon footprint of a floor of the building. When a registered user sets their preference value for SELTEM, the presence of that user in a zone will mean that their preference value is taken into account in setting the actual current temperature in the zone (NORMTEM) to the average of all registered users present in the zone.

It would be possible to bring other components under scrutiny. If a user can set a preference value for any variable that in practice is controlled by the preference values of a whole population of users, the potential impact of the individual's preference value (if the variable were actually to be set to it) can be calculated and demonstrated. For example, this might be the amount of water used to flush each toilet or an amount to be contributed from personal salaries to carbon offset schemes.

Since SELSCENE and SELTEM are units of actual light level and temperature settings, it would be possible to use values for NORMLUX and NORMTEM which belong to another location, in which case the change in carbon footprint C-PER-CCR would give a measure of the difference an individual might make by altering light and temperature settings in that other location. For example, instead of using the normal values of light and temperature levels for the environment the user is actually in, the values could be the normal values of a control floor of the same building or even another building as long as there are metered energy supplies to lights and/or temperature controlling devices but perhaps no feedback to individual users. If that's the case, C-DALI-ENEh would be the metered energy supply per hour to the lights of the control floor, PEOPLE1 would be the normal occupancy of the control floor and C-ACF1-ENEh would be the metered energy supply per hour to the temperature controlling devices of the control floor. This arrangement could be used to demonstrate for instance a potential reduction in individual carbon footprint for users located on the control floor if moved to the floor with feedback.

In practice, PEOPLE1 may be known or can be calculated, depending on the system in place to support the location server 120. If this monitors the location of all personnel, then PEOPLE1 will be known accurately, for example by counting received location signals for different users in the environment. The energy data processor 215 might incorporate a counter for this purpose. However, if user-tracking is done on a voluntary or sampled basis, it may be necessary to estimate PEOPLE1. This might be done by taking the estimated average number of non-tracked people present on a floor at any particular time and adding the known average number of tracked people present.

It can be seen from the above that the way in which the actual carbon footprint per hour of energy use on the floor of a building is affected by a person changing their preference values in the MIS database 230 is not direct. Metered energy consumption on that floor may or may not change as a result of changes in preference values for SELTEM and SELSCENE. Whether metered energy consumption will change for any one individual is affected by the preference values of other people present. Also, changes in light and temperature settings are likely to be made in discrete amounts rather than continuously over a range. An individual may have to change their preference values more than they would normally choose to in order to get a response from the lights and/or temperature controls in their vicinity, or persuade other people to change theirs also.

### 4.2.3 MIS Software 210, 215: GUI 220

A third category of software is the GUI 220 which presents data from the MIS database 230 via a “dashboard” offering images, floor plans, diagrams and plain text. Access to the dashboard GUI 220 is available via a web interface to computers connected to a local area network and to the Internet and can be password protected subject to user status. The GUI 220 can give access to all the data in the MIS database 230, subject to user status. It can give access to the asset register as well as personal profiles and the results output by the data processor 215. Where renewable sources are concerned, these may individually carry passive RFID tags which can be read locally by RFID readers. If a user wishes to obtain data from the asset register, they may be supplied with a mobile computing device such as the Samsung Q1 into which an RFID reader can read the tag of a renewable source 100. The computing device can then search the asset register using the tag data for a source of interest.

Referring to FIG. 6, an example of a screen view of the GUI 220 relating to an individual shows a selection of information that might be made available. This includes common management information such as contact details and biometrics but also preference values and carbon footprint, the latter being expressed graphically as a reduction in footprint as a result of action taken by the user to affect energy usage in the building. The carbon footprint visualisation will be based on calculations made by the energy data processor 215 and might thus show various different aspects of carbon footprint changes. Data shown can also include the following indicators for the last hour:
1. Energy consumed (kWh, £, carbon footprint).
2. Energy saved due to renewables (kWh, £, carbon footprint).

There may also be a link to a report that provides the accumulated energy consumption and the accumulated reduction over various periods due to the renewable energy sources 100 and related to the presence of the user. The energy is presented as values in equivalents of kWh, £, and kg carbon dioxide.

An option via the screen view of the GUI 220 relating to an individual is that the user should be able to control energy consuming devices 105 such as lights 320 or fan-controlled units 325 directly, overriding the user's stored preferences and those of any other users present. This allows the user for example to dim the lights until they see a reduction in carbon footprint. In this case, the reduction in carbon footprint needs to be calculated in the same manner as the calculation of C-PER-CCR described above. It would not be sufficient to wait to see a change in the metered energy consumption since that is only measured as an hourly rate and would be very slow to show the change. In order for the user to see an immediate reduction in carbon footprint due to the user selecting new values to be sent to the lights 320 or fan-controlled units 325, “C-OR-CCR”, almost the same formula as that for C-PER-CCR can be used but those new values can be substituted instead of values for SELSCENE and SELTEM.

Referring to FIG. 7, an example of a screen view of the GUI 220 relating to a building shows the following indicators:
1. outdoor temperature (° C.) and solar irradiance (w/m²).
2. total energy consumption last hour (kWh) and total current power consumption (kW).
3. total energy yield per hour during the current day due to the renewable technology shown as a small column chart.
4. total energy yield last hour due to the renewable technology (kWh, reduced carbon footprint, £) shown as values.
5. accumulated savings due to the renewable technology (% of comparable consumption, kWh, carbon footprint reduction, £).

Optional report types for this screen view include:
1. Type 1 for historical reports of the energy yield. Day reports (yield per hour) and month reports (yield per day) are provided as column charts.
2. Type 2 for technical information from the asset register including a summary of the energy yield.

### 5. USE OF THE GUI 220

Although different views might be appropriate in different circumstances, the GUI 220 offers a start page based on Google Maps (registered trade mark of . . . ) to provide a holistic view of the building. This start view might be a map of the United Kingdom, all buildings whose data is accessible via the MIS database 230 being indicated with an icon. The user can then select a building in which case the region around the building concerned is zoomed in and a more detailed map is shown.

When the user places a cursor on a building icon, a small information panel with the name of the building is shown beside the icon. If the user clicks on the building icon, a larger information panel with an image of the building and some optional information about the building is shown. The user has the option of accessing maps for the location of the building or of entering the MIS database 230 for the building.

The “Dashboard” GUI 220 has an image of the building and either a menu or small images of all assets 100 (renewable energy sources 100) that are included and can be made visible. An information panel and meters show overall energy status of the building. The asset images are links to additional information.

When the user selects an asset from a menu or places the cursor on an asset image, another information panel is shown beside the asset 100. This panel shows energy produced and carbon reduction since start and technology information for the asset concerned taken from the asset register of the MIS database 230. If the user clicks on the asset, a more comprehensive register view will be shown. The following data is normally provided:
1. Outdoor temperature (° C.)
2. Solar irradiance (W/m²)
3. Current power generated or consumed for asset concerned (kW)
4. Total energy yield last hour for asset concerned (kWh, £, CO2).

When the user clicks on a virtual link for a specific floor on the building image, the corresponding floor plan will be shown. This floor plan will show some assets 100 which are links to additional information. When the user places the cursor on an asset image, a panel will be shown beside the asset providing information about the asset 100. The information is energy status, carbon footprint, and specified technology data from the asset register. If the user clicks on the asset image a more comprehensive register view is shown.

When the user clicks on a “3D-view” icon a separate application is started in a new window. The 3D-view shows a zoomable image of the floor area.

At the bottom of all views except the Google Maps and any external application there is a dashboard panel that is always shown. This panel provides the summarized energy status and carbon footprint for the view concerned. There may also be three buttons to get direct access to the historical reports for previous day, last month, and last year.

The location of people who are tagged with an active RFID tag is shown on the floor plan view. All tags are shown with a symbol. If a tag is marked for tracking, the symbol becomes red and a small panel with the name of the bearer can be shown at the side of the view. The panel also shows energy consumed, energy saved due to the renewable energy sources 100, and carbon footprint for this person in near real time. (These values are based on figures for the environment as a whole, divided by current or average occupancy.)

### 6. USER GROUPING FOR ENERGY EFFICIENCY

A powerful advantage of the combination of the preference values for individuals and the location server 120 is that users can be monitored in terms of where they spend time in a building. This can be analysed alongside their preference values. It becomes possible to optimise groupings of individuals for maximum efficiency. For example, it is possible to group workstations for individuals choosing high light levels near natural light sources such as the windows. However, a user who spends little time in the building might be given less weight in workplace allocation than a user who is constantly present.

### 7. RELATIVE MEASUREMENTS

Energy yields and carbon footprints are generally measured for a floor of a building, or for the whole building, in order to gauge the level of improved performance in relation to control floors or buildings. Improved performance might arise from a number of factors such as the provision of renewable energy sources 100 or DALI controls or even low technology factors such as insulation. Measures that might be compared between a test floor or building and a control floor or building are as follows:
1. total energy yield last hour due to the renewable technology (kWh, reduced carbon footprint, £)
2. total power gain (kW) (the difference between a control floor and a test floor)
3. energy savings per hour during the current day.
4. accumulated savings due to the renewable technology (% of comparable consumption, kWh, carbon footprint reduction, footprint symbols, £)
5. current consumption values for power (kW) and energy (kWh—last hour) for the test floor and the control floor.

Optional report types include:
1. Type 1 for historical reports of the energy yield. Day reports (yield per hour) and month reports (yield per day) can be provided as column charts.
2. Type 2 for technical information from the asset register including a summary of the energy yield.

Thus embodiments of the invention offer a powerful tool, both for carbon awareness and benchmarking/standardisation, which can be used for example by the individual or a building manager, in real time, to interpret user behaviour directly in terms of energy usage and carbon footprint. Further, comparisons can be made against a base measurement as a benchmark so that changes can be monitored, either with reference to another environment or to a control floor.

1. Resource consumption control apparatus for controlling resource consumption by at least one resource consuming device in an environment, the resource consumption control apparatus comprising: i) a user location signal input for receiving location signals indicating location of a user in the environment; ii) a preference value reader for reading one or more preference values from a database in relation to the at least one resource consuming device for one or more users; and iii) a control signal setting device and output for setting and sending one or more control signals to adjust the resource consumption of at least one resource consuming device in accordance with one or more preference values read from the database for a user whose location is indicated by a received location signal.

2. Resource consumption control apparatus according to claim 1, further comprising metering apparatus for metering resource consumption in relation to the environment.

3. Resource consumption control apparatus according to claim 1, wherein the resource comprises energy and the resource consuming device comprises an energy consuming device.

4. Resource consumption control apparatus according to claim 1, further comprising a preference value processor for converting a set of one or more preference values to a measure of resource consumption and/or carbon footprint.

5. Resource consumption control apparatus according to claim 1, wherein the control signal setting device is adapted to set a control signal in relation to the resource consumption of a resource consuming device in accordance with a combination of preference values stored in the preferences database for all users whose locations are indicated by location signals received in the same time period as having access to that device.

6. Resource consumption control apparatus for controlling resource consumption by at least one resource consuming device in an environment, the resource consumption control apparatus comprising: i) a preference value reader for reading one or more preference values from a database in relation to the resource consumption of at least one resource consuming device for at least one user; ii) a control signal device and output for selecting and sending a control signal to set the level of resource consumption of said at least one resource consuming device, the control signal being at least partly determined by at least one preference value read from the database; iii) a resource consumption meter for measuring the resource consumption of said at least one resource consuming device; and iv) a change calculator for calculating a change in relation to the measured resource consumption, which calculated change is attributable to one or more preference values for said one user in relation to the resource consuming device(s).

7. Resource consumption control apparatus according to claim 6, wherein said one or more control signals is at least partly determined by preference values read from the database in relation to said one user and at least one further user.

8. Resource consumption control apparatus according to claim 6 wherein the change calculator is adapted to calculate said change by converting the measured resource consumption to a measured resource consumption per user in the environment, and calculating the change in resource consumption per user that would occur in the event of selection and sending of a fresh control signal based on the preference value(s) for said one user in relation to the at least one resource consuming device.

9. Resource consumption control apparatus according to claim 6, wherein the resource comprises energy.

10. Resource consumption control apparatus according to claim 9, wherein the change calculator calculates a change in carbon footprint in relation to the change in resource consumption per user.

11. Resource consumption control apparatus according to claim 6, further comprising an override control signal device for use in overriding control signals based on stored preference values to set the level of resource consumption of said at least one resource, and wherein the apparatus comprises a further change calculator for calculating a change in relation to the measured resource consumption, which calculated change is attributable to the content of an override control signal sent by use of the override control signal device.

12. Resource consumption control apparatus according to claim 6, further comprising a comparator for comparing a value for resource consumption based on one or more measurements by the resource consumption meter with a reference value.

13. Resource consumption control apparatus according to claim 6, further comprising a preference values database for access by the preference value reader to read one or more preference values.

14. Resource consumption control apparatus according to claim 6, further comprising a user interface for receiving preference value inputs for entering or modifying preference values in the database.

15. Resource consumption control apparatus according to claim 6, wherein the database is adapted for storage of user profiles and preference values are stored in said user profiles.

16. Resource consumption control apparatus according to claim 15, having a change calculator for calculating a change in relation to the measured resource consumption, which calculated change is attributable to one or more preference values for said one user in relation to the resource consuming device(s), and further comprising a display signal output to the user interface for displaying a calculated change.

17. Resource consumption control apparatus according to claim 16, being adapted to output a display signal for displaying a calculated change in response to a received preference value input.

18. Resource consumption control apparatus according to claim 6, the apparatus being provided with a counter for counting the number of users present in the environment.

19. Resource consumption control apparatus according to claim 6, the apparatus being provided with an input for data relating to resource consumption per user in a reference environment and the change calculator is adapted to calculate the difference in resource consumption per user in the environment and in the reference environment.

20. Resource consumption control apparatus according to claim 6, the apparatus being adapted to control resource consumption by at least one resource consuming device in each of two or more environments, control signals for resource consuming devices in each environment being selectable independently of each other environment.

21. Resource consumption control apparatus according to claim 6, wherein the preference value reader is adapted to read a preference value from a database in relation to the resource consumption of each of at least two resource consuming devices for at least one user and the control signal device is adapted to select a control signal to set the level of resource consumption of each of said resource consuming devices.

22. Resource consumption control apparatus according to claim 21 wherein said two resource consuming devices comprise a temperature controlling device and a lighting device.

23. Resource consumption control apparatus according to claim 6, wherein the control signal device is adapted to select a control signal to set the level of resource consumption of a resource consuming device, the control signal being at least partly determined by the average of two or more preference values read from the database.

24. Resource consumption control apparatus according to claim 6, wherein the control signal device is adapted to select a control signal to set the level of resource consumption of a resource consuming device, the control signal being at least partly determined by the highest of two or more preference values read from the database.

25. A method of controlling resource consumption by one or more resource consuming devices in an environment, the method comprising the steps of: i) detecting the location of at least one user in the environment; ii) obtaining at least one preference value relating to resource consumption in respect of the at least one user; and ii) sending a control signal to a resource consuming device relevant to the location, the control signal being at least partly determined by the at least one preference value.

26-27. (canceled)
